(19) United States
(12) Patent Application Publication
(10) Pub. No.: US 2024/0355536 A1
(43) Pub. Date: Oct. 24, 2024

(54) COIL COMPONENT AND MANUFACTURING METHOD OF THE SAME

(71) Applicant: SAMSUNG ELECTRO-MECHANICS CO., LTD., Suwon-si (KR)

(72) Inventors: No Il Park, Suwon-si (KR); In Young Kang, Suwon-si (KR); Ic Seob Kim, Suwon-si (KR)

(73) Assignee: SAMSUNG ELECTRO-MECHANICS CO., LTD., Suwon-si (KR)

(21) Appl. No.: 18/581,907

(22) Filed: Feb. 20, 2024

(30) Foreign Application Priority Data
Apr. 17, 2023 (KR) 10-2023-0050139

(51) Int. Cl. H01F 27/29; H01F 27/30; H01F 41/04

(52) U.S. Cl. CPC H01F 27/292; H01F 27/306; H01F 41/041

(57) ABSTRACT

A coil component according to an embodiment of the present disclosure may include: a body having a first surface and a second surface and each having a recess formed therein, and a third surface and a fourth surface; a support member; a coil including first and second coil portions disposed on the support member, an internal via for connecting the first and second coil portions, a first lead-out portion extending from an outermost turn of the first coil portion, a first sub lead-out portion, a first external via for connecting the first lead-out portion and the first sub lead-out portion, and a second lead-out portion extending from an outermost turn of the second coil portion; a first external electrode; and a second external electrode, wherein at least a portion of the first external via may be in contact with the first external electrode.

### CROSS-REFERENCE TO RELATED APPLICATION(S)

This application claims benefit of priority to Korean Patent Application No. 10-2023-0050139 filed on Apr. 17, 2023, in the Korean Intellectual Property Office, the disclosure of which is incorporated herein by reference in its entirety.

### TECHNICAL FIELD

The present disclosure relates to a coil component and a manufacturing method of the same.

### BACKGROUND

An inductor, a coil component, is a representative passive electronic component used in electronic devices, along with a resistor and a capacitor.

As electronic devices are gradually implemented with higher levels of performance and become smaller, the number of electronic components used in the electronic devices is also increasing and becoming more compact.

On the other hand, it is advantageous for a coil component for integration to have a structure in which external electrodes are disposed only on a mounting surface, and in the case of a low-profile coil component, a structure capable of increasing the reliability of a connection between the external electrode and the coil is required.

The information disclosed in the Background section above is to aid in the understanding of the background of the present disclosure, and should not be taken as acknowledgement that this information forms any part of prior art.

### SUMMARY

An aspect of the present disclosure is to increase connection reliability between a coil and an external electrode in a thin coil component corresponding to a bottom electrode structure.

An aspect of the present disclosure is to provide a coil component having a bottom electrode structure, simultaneously with increasing an effective volume and decreasing coil resistance R_{dc}.

According to an aspect of the present disclosure, a coil component may include: a body having a first surface and a second surface opposing each other in a first direction and each having a recess formed therein, and a third surface and a fourth surface connecting the first surface and the second surface and opposing each other in a second direction; a support member disposed in the body and having one surface and the other surface opposing each other; a coil including first and second coil portions disposed in the support member and having at least one turn, an internal via for connecting the first and second coil portions, a first lead-out portion extending from an outermost turn of the first coil portion to the first surface, a first sub lead-out portion disposed on the other surface of the support member, a first external via for connecting the first lead-out portion and the first sub lead-out portion, and a second lead-out portion extending from an outermost turn of the second coil portion to the second surface; a first external electrode disposed on the third surface and extending onto the recess of the first surface to be connected to the first lead-out portion; and a second external electrode disposed on the third surface and extended into a recess of the second surface to be connected to the second lead-out portion, in which at least a portion of the first external via is in contact with the first external electrode.

According to another aspect of the present disclosure, a coil component may include: a body having a first surface and a second surface each having a recess formed therein and opposing each other in a first direction, and having a third surface and a fourth surface connecting the first surface and the second surface and opposing each other in a second direction; a support member disposed in the body; a coil portion disposed on at least one surface of the support member; a lead-out portion extending from an outermost turn of the coil portion to the first surface; an external electrode disposed on the third surface and extending onto the recess of the first surface; and an external via for connecting the lead-out portion and the external electrode, in which at least a portion of the external electrode is in contact with the external via and the support member.

According to still another aspect of the present disclosure, a coil component may include: a body having a first surface and a second surface each having a recess formed therein and opposing each other in a first direction, and having a third surface and a fourth surface connecting the first surface and the second surface and opposing each other in a second direction; a support member disposed in the body; a coil portion disposed on at least one surface of the support member; a lead-out portion extending from an outermost turn of the coil portion to the first surface; an external electrode disposed on the third surface and extending onto the recess of the first surface; and an external via penetrating through the support member to connect the lead-out portion and at least a portion of the external electrode.

According to yet aspect of the present disclosure, a manufacturing method of a coil component may include: forming a plurality of via holes in a support member; disposing a seed layer on an internal surface of the via hole and the support member; disposing and patterning a plating resist in the support member; forming a coil through plating in the support member; forming an insulating film on a surface of the coil; forming a body by compressing and curing a plurality of magnetic sheets in a vertical direction of the support member in which the coil is disposed; forming a recess by cutting a portion of the body from one surface of the body; disposing an insulating layer on a partial region of one surface of the body and disposing an external electrode on a remaining region and the recess; and separating a central region of the recess into individual coil components by dicing, in which the coil includes an external via disposed in at least one of the plurality of via holes, and at least a portion of the external electrode is disposed to come into contact with the external via.

One effect of the present disclosure is to increase connection reliability between a coil and an external electrode in a thin coil component corresponding to a bottom electrode structure.

One effect of the present disclosure is to provide a coil component having a bottom electrode structure, simultaneously with increasing an effective volume and decreasing coil resistance R_{dc}.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective view schematically illustrating a coil component according to a first embodiment of the present disclosure;

FIG. 2 is an exploded perspective view of FIG. 1;

FIG. 3 is a cross-sectional view taken along line I-I′ of FIG. 1;

FIG. 4 is a cross-sectional view taken along the line II-II′ of FIG. 1;

FIG. 5 is a plan view of FIG. 1;

FIG. 6 is a view illustrating a coil component according to a second embodiment of the present disclosure and is a view corresponding to FIG. 3;

FIG. 7 is a view illustrating a coil component according to a third embodiment of the present disclosure and is a view corresponding to FIG. 5;

FIG. 8 is a view illustrating a coil component according to a modified example of a third embodiment of the present disclosure, and is a view corresponding to FIG. 7;

FIG. 9 is a view illustrating a coil component according to a fourth embodiment of the present disclosure and is a view corresponding to FIG. 3;

FIG. 10 is a view illustrating a coil component according to a fifth embodiment of the present disclosure and is a view corresponding to FIG. 3;

FIG. 11 is a view illustrating a coil component according to a modified example of the fifth embodiment of the present disclosure, and is a view corresponding to FIG. 10;

FIG. 12 is a view illustrating a coil component according to a sixth embodiment of the present disclosure and is a view corresponding to FIG. 5;

FIG. 13 is a view illustrating a coil component according to a modified example of the sixth embodiment of the present disclosure and is a view corresponding to FIG. 12;

FIG. 14 is a view illustrating a coil component according to a seventh embodiment of the present disclosure and is a view corresponding to FIG. 3;

FIG. 15 is a view illustrating a coil component according to an eighth embodiment of the present disclosure and is a view corresponding to FIG. 3; and

FIG. 16 is a flowchart illustrating a method of manufacturing a coil component according to an embodiment of the present disclosure.

### DETAILED DESCRIPTION

The terms used in the present application are used only to describe specific embodiments, and are not intended to limit the disclosed technology. In this specification, the singular also includes the plural unless specifically stated otherwise in the phrase. It will be further understood that the terms “comprises,” “comprising,” “includes” and/or “including,” when used herein, specify the presence of stated features, integers, steps, operations, elements, components and/or combinations thereof, but do not preclude the presence or addition of one or more other features, integers, steps, operations, elements, components, and/or groups thereof. Furthermore, throughout the specification, the term “on” means positioning above or below the object portion, but does not essentially mean positioning on the upper side of the object portion based on a gravity direction.

The terms “coupled to,” “combined to,” and the like, may not only indicate that elements are directly and physically in contact with each other, but may also include the configuration in which the other element is interposed between the elements such that the elements are also in contact with the other component.

In the drawings, sizes and thicknesses of elements illustrated in the drawings are indicated as examples for ease of description, and example embodiments in the present disclosure are not limited thereto.

In the drawings, an L direction may be defined as a first direction or a longitudinal direction, a W direction may be a second direction or a width direction, and a T direction may be a third direction or a thickness direction.

In the descriptions described with reference to the accompanied drawings, the same elements or elements corresponding to each other will be described using the same reference numerals, and overlapping descriptions will not be repeated.

Various types of electronic components are used in electronic devices, and between these electronic components, various types of coil components may be appropriately used for the purpose of removing noise.

In other words, coil components in electronic devices may be used as a power inductor, a high frequency inductor, a general bead, a high frequency bead, and a common mode filter.

### First Embodiment

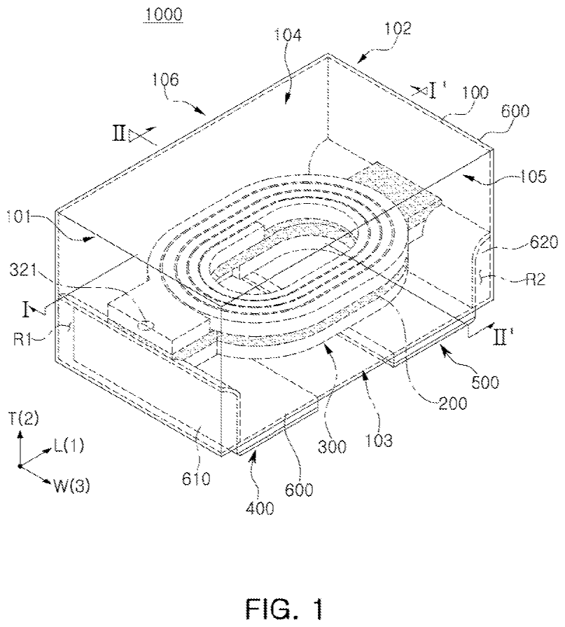

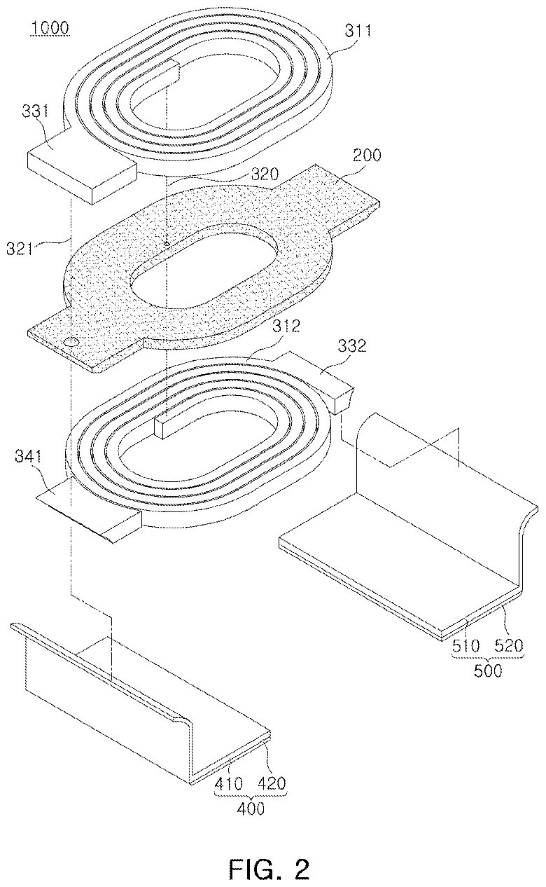

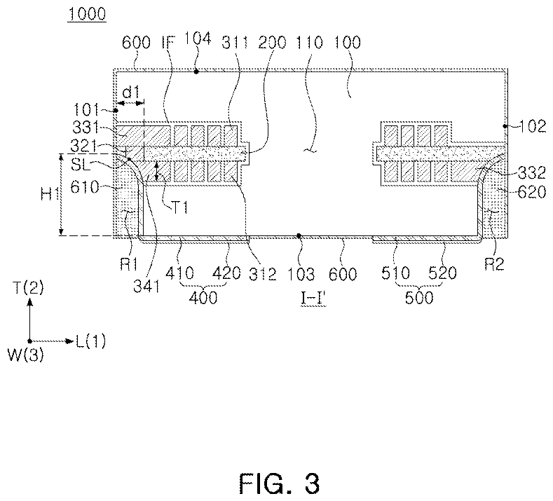

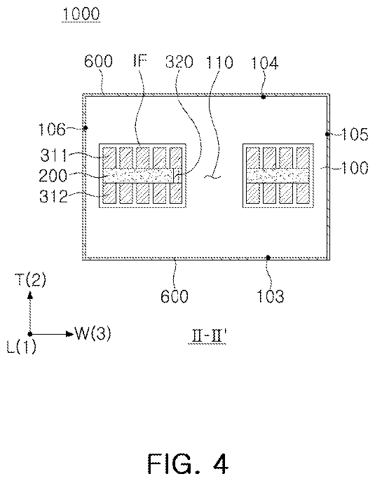

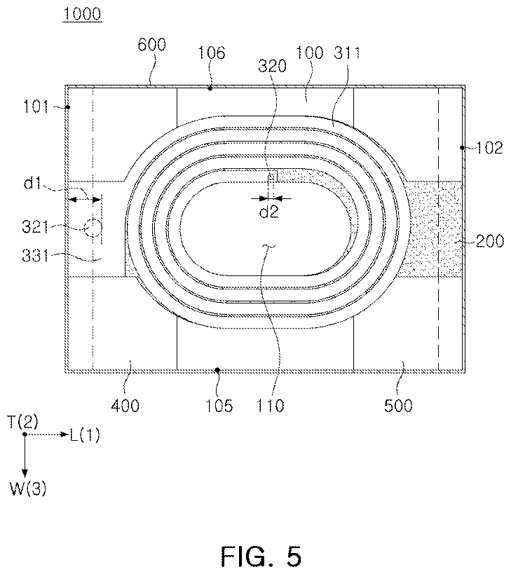

FIG. 1 is a perspective view schematically illustrating a coil component according to a first embodiment of the present disclosure. FIG. 2 is an exploded perspective view of FIG. 1. FIG. 3 is a cross-sectional view taken along line I-I′ of FIG. 1. FIG. 4 is a cross-sectional view taken along the line II-II′ of FIG. 1. FIG. 5 is a plan view of FIG. 1.

Referring to FIGS. 1 to 5, a coil component 1000 according to the first embodiment of the present disclosure may include a body 100, a support member 200, a coil 300, and external electrodes 400 and 500, and may further include an insulating layer 600 covering the body 100.

The coil 300 of the coil component 1000 according to the present embodiment may include a first external via 321 for connecting a first lead-out 331 disposed on one surface of the support member 200 and a first sub lead-out 341 disposed on the other surface of the support member 200, and at least a portion of the first external via 321 may be disposed to be in contact with the first external electrode 400. Accordingly, in a thinned coil component, the connection reliability between the coil 300 and the external electrodes 400 and 500 may be improved, an effective volume increases while having a bottom electrode structure, and coil resistance Rac decreases.

Hereinafter, main components constituting the coil component 1000 according to an example embodiment of the present disclosure will be described in detail.

The body 100 forms an appearance of the coil component 1000 according to an embodiment of the present disclosure, and the support member 200 and the coil 300 are embedded therein.

The body 100 may be formed in a hexahedral shape as a whole.

The body 100 includes a first surface 101 and a second surface 102 opposing each other in a longitudinal direction L (a first direction), a third surface 103 and a fourth surface 104 opposing each other in a thickness direction T (a second direction), and a fifth surface 105 and a sixth surface 106 opposing each other in a width direction W (a third direction). Each of the first surface 101 and the second surface 102, and the fifth surface 105 and the sixth surface 106 of the body 100 may correspond to a wall surface of the body 100 for connecting the third surface 103 and the fourth surface 104 of the body 100.

For example, the coil component 1000 according to an example embodiment of the present disclosure in which the external electrodes 400 and 500 are formed may be formed to have a length of 2.5 mm, a width of 2.0 mm, and a thickness of 0.8 mm, may have a length of 2.0 mm, a width of 1.2 mm, and a thickness of 0.6 mm, may have a length of 1.6 mm, a width of 0.8 mm, a thickness of 0.6 mm, may have a length of 1.4 mm, a width of 1.2 mm, a thickness of 0.65 mm, may have a length of 1.0 mm, a width of 0.7 mm, a thickness of 0.65 mm, may have a length of 0.8 mm, a width of 0.4 mm, or a thickness of 0.65 mm, or may have a length of 0.8 mm, a width of 0.4 mm, and a thickness of 0.5 mm, but the present disclosure is not limited thereto. On the other hand, since the above-described exemplary dimensions for the length, width, and thickness of the coil component 1000 refer to dimensions not reflecting process errors, dimensions within a range that may be recognized as process errors should be considered to correspond to the exemplary dimensions described above.

Based on an optical microscope image or a scanning electron microscope (SEM) image of a longitudinal (L)-thickness (T) cross-section taken in a central portion of the coil component 1000 in the width direction W, the length of the coil component 1000 described above may denote a maximum dimension among dimensions of each of a plurality of line segments spaced apart from each other in the thickness direction T, connecting two outermost boundary lines opposing each other in the longitudinal direction L of the coil component 1000 illustrated in the image in parallel with the longitudinal direction L. Alternatively, the length of the coil component 1000 may denote a minimum value among dimensions of each of the plurality of line segments described above. Alternatively, the length of the coil component 1000 may denote at least three or more arithmetic average values among the dimensions of each of the plurality of line segments described above. Here, the plurality of line segments in parallel with the longitudinal direction L may be spaced apart from each other at equal intervals in the thickness direction T, but the scope of the present disclosure is not limited thereto.

Based on an optical microscope image or a scanning electron microscope (SEM) image of a longitudinal (L)-thickness direction (T) cross-section taken in a central portion of the coil component 1000 in the width direction W, the thickness of the coil component 1000 described above may denote a maximum value among dimensions of each of a plurality of line segments spaced apart from each other in the longitudinal direction L, connecting two outermost boundary lines opposing each other in the thickness direction T of the coil component 1000 illustrated in the image in parallel with the thickness direction T. Alternatively, the thickness of the coil component 1000 may denote a minimum value among dimensions of each of the plurality of line segments described above. Alternatively, the thickness of the coil component 1000 may denote at least three or more arithmetic average values among the dimensions of each of the plurality of line segments described above. Here, the plurality of line segments in parallel with the thickness direction T may be spaced apart from each other in the longitudinal direction L, but the scope of the present disclosure is not limited thereto.

Based on an optical microscope image or a scanning electron microscope (SEM) image of a longitudinal (L)-width direction (W) cross-section taken at a central portion of the coil component 1000 in the thickness direction T, the width of the coil component 1000 described above may denote a maximum value among dimensions of each of a plurality of line segments spaced apart from each other in the longitudinal direction L, connecting two outermost boundary lines opposing each other in the width direction W of the coil component 1000 illustrating in the image in parallel with the width direction W. Alternatively, the width of the coil component 1000 may denote a minimum value among dimensions of each of the plurality of line segments described above. Alternatively, the width of the coil component 1000 may denote at least three or more arithmetic average values among the dimensions of each of the plurality of line segments described above. Here, the plurality of line segments in parallel with the width direction W may be space apart from each other at equal intervals in the length direction L, but the scope of the present disclosure is not limited thereto.

Furthermore, each of the length, width, and thickness of the coil component 1000 may be measured by a micrometer measurement method. The micrometer measurement method may be measured by setting a zero point with a micrometer such as a Gage Repeatability and Reproducibility (R&R), inserting the coil component 1000 according to this example embodiment between tips of the micrometer, and turning a measurement lever of the micrometer. On the other hand, in measuring the length of the coil component 1000 using the micrometer measurement method, the length of the coil component 1000 may refer to a value measured once, or may refer to an arithmetic average of values measured multiple times. This may be applied equally to the width and thickness of the coil component 1000.

The body 100 may include a magnetic material and a resin. Specifically, the body 100 may be formed by stacking one or more magnetic composite sheets in which the magnetic material is dispersed in the resin. However, the body 100 may have a structure other than a structure in which the magnetic material is dispersed in the resin. For example, the body 100 may be formed of a magnetic material such as ferrite.

The magnetic material may be ferrite or metallic magnetic powder particles.

Examples of the ferrite may include at least one of a spinel type ferrite such as a Mg—Zn type, a Mn—Zn type, a Mn—Zg type, a Cu—Zn type, a Mg—Mn—Sr type and a Ni—Zn type, a hexagonal ferrite such as a Ba—Zn type, a Ba—Mg type, a Ba—Ni type, a Ba—Co type and a Ba—Ni—Co type, a garnet-type ferrite such as a Y type, and a Li-based ferrite.

Examples of the magnetic metal powder particles may include at least one selected from the group consisting of iron (Fe), silicon (Si), chromium (Cr), cobalt (Co), molybdenum (Mo), aluminum (Al), niobium (Nb), copper (Cu), boron (B), zirconium (Zr), hafnium (Hf), phosphorus (P), and nickel (Ni). For example, the magnetic metal powder particles may be at least one of pure iron powder particles, Fe—Si-based alloy powder particles, Fe—Si—Al-based alloy powder particles, Fe—Ni-based alloy powder particles, Fe—Ni—Mo-based alloy powder particles, Fe—Ni—Mo—Cu-based alloy powder particles, Fe—Co-based alloy powder particles, Fe—Ni—Co-based alloy powder particles, Fe—Cr-based alloy powder particles, Fe—Cr—Si-based alloy powder particles, Fe—Si—Cu—Nb-based alloy powder particles, Fe—Ni—Cr-based alloy powder particles, and Fe—Cr—Al-based alloy powder particles.

The magnetic metal powder particles may include amorphous and/or crystalline. For example, the magnetic metal powder particles may be a Fe—Si—B—Cr-based amorphous alloy powder particles, but the present disclosure is not necessarily limited thereto.

Each of the magnetic metal powder particles may have an average diameter of about 0.1 μm to about 30 μm, but the present disclosure is not limited thereto.

The body 100 may include two or more types of magnetic materials dispersed in a resin. Here, the fact that the magnetic materials are of different kinds denotes that the magnetic materials dispersed in the resin are distinguished from each other by any one of an average diameter, a composition, crystallinity, and a shape.

The resin may include epoxy, polyimide, and a liquid crystal crystalline polymer alone or in combination, and the present disclosure not limited thereto.

The body 100 includes a core 110 penetrating through the support member 200 and the coil 300. The core 110 may be formed by filling through-holes inside the support member 200 and the coil 300 with magnetic composite sheets, but the present disclosure is not limited thereto.

Referring to FIGS. 1 and 3, recesses R1 and R2 may be formed in the first surface 101 and the second surface 102 of the body 100, respectively.

Specifically, the recess R1 of the first surface 101 may be formed between the first surface 101 and the third surface 103 of the body 100, and the recess R2 of the second surface 102 may be formed between the second surface 102 and the third surface 103 of the body 100.

The recesses R1 and R2 may extend to the fifth and sixth surfaces 105 and 106 of the body 100 in the third direction W. However, the scope of the present disclosure is not limited thereto, and for example, the recesses R1 and R2 may not extend to the fifth surface 105 and the sixth surface 106 and may be formed to be smaller than a width of the body 100 in the third direction W.

Meanwhile, the recesses R1 and R2 do not extend to the fourth surface 104 of the body 100. That is, the recesses R1 and R2 do not penetrate through the body 100 in the second direction T of the body 100.

The recesses R1 and R2 be formed by performing pre-dicing on one surface of a coil bar along a virtual boundary line that matches the third direction W of each coil component among virtual boundary lines for individualizing each coil component, on a coil bar level before each coil component is individualized. By means of the pre-dicing, a depth of the first sub lead-out portion 341 and the second lead-out portion 332 is adjusted so that the first sub lead-out portion 341 and the second lead-out portion 332 may be exposed to recesses R1 and R2.

Referring to FIG. 3, the recesses R1 and R2 of the coil component 1000 according to an example embodiment may be formed to expose a portion of the support member 200. That is, by forming a height H1 of the recesses R1 and R2 in the second direction T to be higher than a height at which the support member 200 is disposed, each of the recesses R1 and R2 may be formed by exposing only at least a portion of the first sub lead-out portion 341 or the second lead-out portion 332 but also at least a portion of the support member 200.

Specifically, in the coil component 1000 according to an example embodiment, at least a portion of a first external via 321 that penetrates the support member 200 and connects the fit t lead-out portion 331 and the first sub lead-out portion 341 may be exposed to the recess R1 of the first surface 101.

Internal surfaces of the recesses R1 and R2 may include internal walls, substantially parallel to the first surface 101 and the second surface 102 of the body 100, and a bottom surface formed in a direction crossing the internal wall.

However, the scope of the present disclosure is not limited thereto, and as in this example embodiment, the internal surface of the recess R1 of the first surface 101 may be formed to have a curved shape for connecting the first surface 101 and the third surface 103 of the body 100 on the L-T cross-section so that the internal wall and the bottom surface described above may not be distinguished from each other, and may have an irregular shape. Similarly, the internal surface of the recess R2 of the second surface 102 may be formed to have a curved shape for connecting the second surface 102 and the third surface 103 of the body 100 on the L-T cross-section so that the internal wall and the bottom surface described above may not be distinguished from each other, and may have an irregular shape.

The support member 200 may be disposed in the body 100 and may have one surface and the other surface opposing each other. Based on a direction of FIG. 1, one surface of the support member 200 corresponds to an upper surface, and the other surface of the support member 200 corresponds to a lower surface.

The support member 200 supports the coil 300. Referring to FIGS. 2 and 3, the support member 200 may support a first coil portion 311 and the first lead-out portion 331 disposed on one surface thereof, and a second coil portion 312, the second lead-out portion 332, and the first sub lead-out portion 341 disposed on the other surface.

On the other hand, the coil 300 corresponds to a winding coil, and when the coil 300 has a coreless structure, the support member 200 may be excluded according to an example embodiment.

Referring to FIG. 3, at least a portion of the support member 200 of the coil component 1000 according to an example embodiment may be exposed to the recesses R1 and R2 and may be in contact with the first external electrode 400 or the second external electrode 500.

As the height H1 of the recesses R1 and R2 in the thinned coil component 1000 is formed to be higher than an arrangement height of the support member 200, this structure may be implemented by removing a portion of the support member 200 by a dicing tip in the pre-dicing process. Accordingly, since a first external via 321 to be described below and the first external electrode 400 may be in directly contact with each other, connection reliability between the coil 300 and the first external electrode 400 may be improved, and the second external electrode 500 may also have a larger contact area with the coil 300, thereby having an effect of reliability and reducing a improving the connection resistance component R_{dc}.

The support member 200 may be formed of an insulating material including a thermosetting insulating resin such as an epoxy resin, a thermoplastic insulating resin such as polyimide, or a photosensitive insulating resin, or may be formed of an insulating material in which a reinforcing material such as glass fiber or an inorganic filler is impregnated in the insulating resin. For example, the support member 200 may be formed of materials such as Prepreg, an Ajinomoto Build-up Film (ABF), FR-4, a Bismaleimide Triazine (BT) resin, a photo-imageable dielectric (PID), and a Copper Clad Laminate (CCL), but the present disclosure is not limited thereto.

As inorganic fillers, at least one selected from the group consisting of silica (SiO₂), alumina (Al₂O₃), silicon carbide (Sic), barium sulfate (BaSO₄), talc, mud, mica powder particles, aluminum hydroxide (Al(OH)₃), magnesium hydroxide (Mg(OH)₂), calcium carbonate (CaCO₃), magnesium carbonate (MgCO₃), magnesium oxide (MgO), boron nitride (BN), aluminum borate (ALBO₃), barium titanate (BaTiO₃), and calcium zirconate (CaZrO₃) may be used.

When the support member 200 is formed of an insulating material including a reinforcing material, the support member 200 may provide better rigidity. When the support member 200 is formed of an insulating material that does not include glass fibers, it may be advantageous to reduce the thickness of the component by reducing a total thickness (i.e., a sum of dimensions of each of the coil 300 and the support member 200 in the second direction T of FIG. 1) of the support member 200 and the coil 300. When the support member 200 is formed of an insulating material including a photosensitive insulating resin, the number of processes for forming the coil 300 may decrease to reduce production costs, and an internal via 320 and an external via 321 may be finely formed. The thickness of the support member 200 may be, for example, 10 μm or more and 50 μm or less, but the present disclosure is not limited thereto.

The coil 300 is buried in the body 100 to express the characteristics of the coil component. For example, when the coil component 1000 according to this example embodiment is utilized as a power inductor, the coil 300 may function to stabilize the power of an electronic device by storing an electric field as a magnetic field and maintaining an output voltage.

The coil 300 may include a first coil portion 311, a second coil portion 312, a first lead-out portion 331, a second lead-out portion 332, and a first sub lead-out portion 341, and may further include an internal via 320 for connecting the first coil portion 311 to the second coil portion 312, and a first external via 321 for connecting the first lead-out portion 331 to the first sub lead-out portion 341.

Referring to FIG. 3, based on the direction of FIG. 3, the first coil portion 311 and the first lead-out portion 331 may be disposed on one surface (upper surface) of the support member 200 opposing the fourth surface 104 of the body 100, and the second coil portion 312, the second lead-out portion 332, and the first sub lead-out portion 341 may be disposed on the other surface (lower surface) of the support member 200 opposing the third surface 103 of the body 100.

Referring to FIGS. 1 to 5, the first coil portion 311 may be disposed on one surface of the support member 200 to form at least one turn around the core 110, and an outermost turn may extend and may be in contact with and connected to the first lead-out portion 331. The first coil portion 311 may have a planar spiral shape, but the present disclosure is not limited thereto, and the first coil portion 311 may also have an angled shape.

The first coil portion 311 may have a number of turns greater than or equal to 3.5 turns wound around the core 110, but the scope of this example embodiment is not limited thereto. Here, the number of turns of the first coil portion 311 may denote the number of turns from a region in which the first coil portion 311 and the internal via 320 are in contact with each other to a region in which the first coil portion 311 and the first lead-out portion 331 are in contact with each other.

The first lead-out portion 331 may be disposed on one surface of the support member 200 and may be disposed to extend from an outermost turn of the first coil portion 311 to the first surface 101 of the body 100. Specifically, the first lead-out portion 331 may be disposed on one surface of the support member 200 and exposed to the first surface 101 of the body 100, and may be covered with the insulating layer 600.

The first lead-out portion 331 may be connected to the first sub lead-out portion 341 of the other surface of the support member 200 through the first portion via 321.

The first sub lead-out portion 341 may be disposed on the other surface of the support member 200, but may be spaced apart from the second coil portion 312, and the first sub lead-out portion 341 may be disposed to be exposed to the recess R1 of the first surface 101 of the body 100 and to be connected to the first external electrode 400.

Referring to FIG. 3, a ratio (H1/T1) of the height H1 of the recess R1 of the first surface 101 in the second direction T to the thickness T1 of the first sub lead-out portion 341 in the second direction T may be 4.4 or more and 6.4 or less.

For example, when the thickness T1 of the first sub lead-out portion 341 in the second direction T is 0.05 mm, the height H1 of the recess R1 of the first surface 101 in the second direction T may be 0.22 mm or more and 0.32 mm or less, but the scope of this example embodiment is not limited thereto.

TABLE 1

| | | | | Exposure | | |
|---|---|---|---|---|---|---|
| | | Thickness | | Thickness | | |
| | | of First | | of First | | |
| | Recess | Sub Lead- | | Lead-out | First | Upper Cover |
| Experimental | Height | out Portion | | Portion | External Via | Area Contact |
| Example | (H1, mm) | (T1, mm) | H1/T1 | (E1, mm) | Contact State | State |
| #1 | 0.21 | 0.05 | 4.2 | 0 | N | N |
| #2 | 0.22 | 0.05 | 4.4 | 0 | Y | N |
| #3 | 0.23 | 0.05 | 4.6 | 0 | Y | N |
| #4 | 0.24 | 0.05 | 4.8 | 0 | Y | N |
| #5 | 0.25 | 0.05 | 5.0 | 0 | Y | N |
| #6 | 0.26 | 0.05 | 5.2 | 0 | Y | N |
| #7 | 0.27 | 0.05 | 5.4 | 0 | Y | N |
| #8 | 0.28 | 0.05 | 5.6 | 0.01 | Y | N |
| #9 | 0.29 | 0.05 | 5.8 | 0.02 | Y | N |
| #10 | 0.30 | 0.05 | 6.0 | 0.03 | Y | N |
| #11 | 0.31 | 0.05 | 6.2 | 0.04 | Y | N |
| #12 | 0.32 | 0.05 | 6.4 | 0.05 | Y | N |
| #13 | 0.33 | 0.05 | 6.6 | 0.05 | Y | Y |

Table 1 above is experimental data in which simultaneously with controlling the ratio (H1/T1) of the height H1 of the recess R1 of the first surface 101 in the second direction T to the thickness T1 of the first sub lead-out portion 341 in the second direction T, a thickness E1 at which the first lead-out portion 331 is exposed to the recess R1 of the first surface 101, whether the recess R1 is in contact with the first external via 321, and whether the recess R1 is in contact with the first lead-out portion 331 are measured. A case of contact is described as “Y,” and a case of non-contact is described as “N,” and in Table 1, “upper cover region” denote a region of the body 100 between the coil 300 and the fourth surface 104.

The sample used in the experiment used a coil component 1000 having a length of 0.8 mm, a width of 0.4 mm, and a thickness of 0.5 mm, in which a thickness of the first sub lead-out portion 341 and the first lead-out portion 331 are 0.05 mm, a thickness of the upper cover region is 0.17 mm, and a thickness of the support member 200 is 0.025 mm.

Referring to Table 1, for Experimental Example #1 in which the ratio (H1/T1) of a height H1 of the recess R1 of the first surface 101 in the second direction T to the thickness T1 of the first sub lead-out portion 341 in the second direction T is less than 4.4, since the first external via 321 is not in contact with the recess R1, a direct connection between the first external via 321 and the first external electrode 400 may not be achieved, which may make it difficult to implement the effect of improving connection reliability and reducing the resistance component R_{dc}.

Meanwhile, from Experimental Example #8 in which the ratio (H1/T1) of the height H1 of the recess R1 of the first surface 101 in the second direction is 5.6 or more, a portion of the first lead-out portion 331 on an upper surface of the support member 200 starts to be exposed to the recess R1, and for Experimental Example #13 in which the ratio (H1/T1) of the height H1 of the recess R1 of the first surface 101 in the second direction T is greater than 6.4, the “upper cover region” which is a region of the body 100 between the coil 300 and the fourth surface 104 is in contact with the recess R1. In this case, the effect of improving the reliability of the connection between the external electrode 400 and the coil 300 is no longer improved, but rather, due to the removal of a portion of the upper cover region, a side effect of reducing inductance may appear as an effective volume of a magnetic body decreases.

Accordingly, when the ratio (H1/T1) of the height H1 of the recess R1 of the first surface 101 in the second direction T to the thickness T1 of the first sub lead-out portion 341 in the second direction T is 4.4 or more and 6.4 or less, it may be possible to minimize the side effect of reducing inductance capacitance while improving the reliability of the connection between the coil 300 and the external electrode 400 and reducing the resistance component Rac of the coil 300.

Next, the second coil portion 312 may be disposed on the other surface of the support member 200 to form at least one turn around the core 110, and an outermost turn thereof may extend and may be in contact with and connected to the second lead-out portion 332. The second coil portion 312 may have a planar spiral shape, but the present disclosure is not limited thereto, and the second coil portion 312 may also have an angled shape.

The second coil portion 312 may have a number of turns greater than or equal to 3.5 wound around the core 110, but the scope of this example embodiment is not limited thereto. Here, the number of turns of the second coil portion 312 may denote the number of turns from a region in which the second coil portion 312 and the internal via 320 are in contact with each other to a region in which the second coil portion 312 and the second lead-out portion 332 are in contact with each other.

The second lead-out portion 332 may be disposed on the other surface of the support member 200 and exposed to the recess R2 of the second surface 102 of the body 100, and may be connected to the second external electrode 500. That is, at least a portion of the second lead-out portion 332 may extend to the recess R2 of the second surface 102 and may come into contact with the second external electrode 500.

On the other hand, in the case of this example embodiment, although the first sub lead-out portion 341 has an asymmetric structure formed only at the first surface 101 of the body 100, the scope of the present disclosure is not limited thereto, another sub lead-out portion disposed on one surface of the support member 200 and connected to the second lead-out portion 332, and exposed to the second surface 102 of the body 100 may be further included. However, in the case of an asymmetric structure in which the first sub lead-out portion 341 is formed only on one surface of the body 100 as in this example embodiment, there may be more space in the body 100 to be filled with a magnetic material, as compared to a symmetrical structure that further includes an additional sub lead-out portion, and accordingly, an effective volume may increase, which may be advantageous in terms of inductance characteristics.

Referring to FIGS. 2 and 4, the internal via 320 is configured to connect the first coil portion 311 and the second coil portion 312 disposed on both surfaces of the support member 200 to each other. Specifically, the internal via 320 may penetrate through the support member 200 to connect ends of innermost turns of each of the first and second coil portions 311 and 312.

Referring to FIGS. 2 and 3, the first external via 321 is configured to connect the first lead-out portion 331 and the first sub lead-out portion 341 disposed on both surfaces of the support member 200 to each other. Specifically, the first external via 321 may penetrate through the support member 200 to connect the first lead-out portion 331 and the first sub lead-out portion 341 to each other.

At least a portion of the first external via 321 of the coil component 1000 according to an example embodiment of the present disclosure may be disposed to be in contact with the first external electrode 400.

At least portion of the first external via 321 may be removed together with a portion of the body 100, the first sub lead-out portion 341, and the support member 200 in the pre-dicing process of forming the recess R1 on the first surface 101 of the body 100.

Accordingly, at least a portion of the first external via 321 may be coplanar with the recess R1 of the first surface 101 of the body 100. Furthermore, a region of the first external via 321 coplanar with the recess R1 of the first surface 101 of the body 100 may be disposed to be in contact with a region of the first external electrode 400 disposed in the recess R1 of the first surface 101 of the body 100.

Furthermore, the first external via 321 may have an upper surface and a lower surface opposing each other in the second direction T, and a cross-sectional area of the lower surface of the first external via 321 may be smaller than a cross-sectional area of the upper surface thereof. This is a structure implemented by removing a portion of the lower region of the first external via 321 together when the recess R1 of the first surface 101 is formed. Here, the upper surface of the first external via 321 may refer to a surface on which the first external via 321 is in contact with the first lead-out portion 331, and the lower surface of the first external via 321 may refer to a surface at which the first external via 321 is in contact with the first sub-withdrawer 341.

The cross-sectional area of the upper surface of the first external via 321 described above may be measured using an Image J program tool, based on an optical microscope image or a SEM image of an L-W cross-section obtained in a center of the coil component 1000 in the second direction T and representing one surface of the support member 200. Furthermore, the cross-sectional area of the lower surface of the first external via 321 may be measured using the Image J program tool based on the optical microscope image or the SEM image of the L-W cross-section obtained in the center of the coil component 1000 in the second direction T and representing the other surface of the support member 200.

Referring to FIG. 3, a surface on which the first external via 321 is in contact with the first external electrode 400 may be formed as an inclined surface SL. The inclined surface SL may be formed in a lower region of the first external via 321, and when the recess R1 of the first surface 101 is processed, a shape thereof may be determined according to a shape of a dicing blade.

Referring to FIGS. 2, 3 and 5, an upper surface of a first external via 321 may have a circular shape, on a cross-section, perpendicular to the second direction T. The fact that the upper surface has the circular shape here does not denote that a radius of an external boundary of the first external via 321 is completely constant, and may denote that even if there is a partial difference in radius or curvature, the upper surface has a shape, substantially close to a circular shape in consideration of process errors.

That is, the first external via 321 may be formed by mechanical drilling or CO₂ laser irradiation to the support member 200, and the recess R1 of the first surface 101 may be formed by a height H1 spaced apart from the upper surface of the first external via 341, and accordingly, since the upper surface of the first external via 341 is not partially removed in the pre-dicing process, the circular shape formed by the mechanical drilling or CO₂ laser irradiation may be maintained.

Referring to FIGS. 3 to 5, on the L-T cross-section obtained in a center of the coil component 1000 in the third direction W according to an example embodiment, a distance d1 in the first direction L from an innermost boundary line between the first external via 321 and the support member 200 to an extension line of an outermost boundary line of the first lead-out portion 331 may be formed to be greater than or equal to a diameter d2 of the internal via 320.

FIG. 5 is a schematic plan view of the coil component 1000 according to an example embodiment in a direction from the fourth surface 104 to the third surface 103. For convenience of description, the drawing is illustrated in the form of a perspective view rather than a cross-section, and dotted lines on the external electrodes 400 and 500 represent a bent shape of the external electrodes 400 and 500 at a height at which the first external electrode 400 is in contact with the lower surface of the first external via 321.

Since a portion of the first external via 321 of this example embodiment is in contact with the first external electrode 400, the first external via 321 may make a connection between the first lead-out portion 331 and the first sub lead-out portion 341 and may also be directly connected to the first external electrode 400. Accordingly, a diameter of the first external via 321 may be formed to be greater than that of the internal via 320, thereby increasing a contact area and reducing the resistance component R_{dc}.

Meanwhile, in this example embodiment, a partial region of the first external via 321 may be removed in the process of forming the recess R1 of the first surface 101, and thus a definition of the diameter of the first external via 321 may be unclear. Accordingly, instead of ‘the diameter of the first external via 321,’ ‘a distance d1 in the first direction L from the innermost boundary line between the first external via 321 and the support member 200 to the extension line of the outermost boundary line of the first lead-out portion 331’ will be compared with a diameter d2 of the internal via 320.

Here, the distance d1 in the first direction L from the innermost boundary line between the first external via 321 and the support member 200 to the extension line of the outermost boundary line of the first lead-out portion 331 may denote at least three or more arithmetic average values among dimensions of each of the plurality of line segments spaced apart from each other in the second direction T, where, based on an optical microscope image or a scanning electron microscope (SEM) image of an L-T cross-section obtained in the center of the coil component 1000 in the third direction W to pass the center of the first external via 321, an innermost boundary line between the first external via 321 and the support member 200 may be connected to an extension line of an outermost boundary line of the first lead-out portion 331, illustrated in the image, in parallel with the first direction L. Here, the plurality of line segments in parallel with the first direction L may be spaced apart from each other at equal intervals in the second direction T, but the scope of the present disclosure is not limited thereto.

Furthermore, the diameter d2 of the internal via 320 may denote at least three or more arithmetic average values among dimensions of each of the plurality of line segments spaced apart from each other in the third direction W, where based on an optical microscope image or a scanning electron microscope (SEM) image of a W-T cross-section obtained in the center of the coil component 1000 in the first direction L to pass the center of the internal via 320, two outermost boundary lines opposing each other in the first direction L of the internal via 320 illustrated in the image are connected in parallel with the first direction L. Here, the plurality of line segments parallel to the third direction (W) may be spaced apart from each other at equal intervals in the second direction T, but the scope of the present disclosure is not limited thereto.

Through a connection between the components described above, a signal input to the first external electrode 400 may be output to the second external electrode 500 through the first sub lead-out portion 341 and the first external via 321, the first lead-out portion 331, the first coil portion 311, the internal via 320, the second coil portion 312, and the second lead-out portion 332. Through this structure, each component of the coil 300 may function as a single coil connected between the first and second external electrodes 400 and 500 as a whole.

Specifically, since the first external electrode 400 is not only connected to the first sub lead-out portion 341 but also to the first external via 321, the reliability of the connection between the coil 300 and the first external electrode 400 may be increased, and the resistance component R_{dc} of the coil 300 may be reduced.

At least one of the first coil portion 311, the second coil portion 312, the internal via 320, the first external via 321, the first lead-out portion 331, the second lead-out portion 332, and the first sub lead-out portion 341 may include at least one conductive layer. For example, when the first coil portion 311, the first lead-out portion 331, and the internal via 320 are formed by plating on the upper surface of the support member 200, each of the first coil portion 311, the first lead-out portion 331, and the internal via 320 may include a first conductive layer formed by electroless plating, and a second conductive layer disposed on the first conductive layer.

The first conductive layer may be a seed layer for forming the second conductive layer on the support member 200 by the plating, and the second conductive layer may be an electroplating layer. Here, the electroplating layer may have a single layer structure or a multilayer structure. The multilayer electroplating layer may be formed in a conformal film structure in which one electroplating layer is covered by the other electroplating layer, and may be formed in a shape in which another electroplating layer is stacked only on one surface of one electroplating layer. A seed layer of the first coil portion 311 and a seed layer of the first lead-out portion 331 may be integrally formed so that no boundary therebetween may be formed, but the present disclosure is not limited thereto. The electroplating layer of the first coil portion 311 and the electroplating layer of the first lead-out portion 331 may be integrally formed so that no boundary lines therebetween may not be formed, but the present disclosure is not limited thereto.

Each of the first coil portion 311, the second coil portion 312, the internal via 320, the first external via 321, the first lead-out portion 331, the second lead-out portion 332, and the first sub lead-out portion 341 may be formed of a conductive material such as copper (Cu), aluminum (Al), silver (Ag), tin (Sn), gold (Au), nickel (Ni), lead (Pb), titanium (Ti), or alloys thereof, but the present disclosure is not limited thereto.

Referring to FIGS. 3 and 4, the coil component 1000 according to an example embodiment may further include an insulating film IF in the body 100.

The insulating film IF may insulate the first coil portion 311, the second coil portion 312, the first lead-out portion 331, the second lead-out portion 332, and the first sub lead-out portion 341 from the body 100.

The insulating film IF may include, for example, parylene, but the present disclosure is not limited thereto. The insulating film IF may be formed by vapor deposition or the like, but the present disclosure is not limited thereto, and the insulating film IF may be formed by stacking the insulating film on both surfaces of the support member 200. On the other hand, the insulating film IF may have a structure including a portion of a plating resist used in forming the coil 300 by electroplating, but the present disclosure is not limited thereto.

Referring to FIGS. 1 to 3, the first external electrode 400 and the second external electrode 500 may be disposed on the third surface 103 of the body 100 to be spaced apart from each other, and the first external electrode 400 may extend to the recess R1 of the first surface 101 and may be connected to the first lead-out portion 331, and the second external electrode 500 may extend to the recess R2 of the second surface 102 and may be connected to the second lead-out portion 331.

Each of the first and second external electrodes 400 and 500 may include a connection portion disposed in the recesses R1 and R2 and connected to the first lead-out portion 331 or the second lead-out portion 332, and a pad portion extending from the connection portion to the third surface 103 of the body 100. The connection portion and the pad portion may be integrally formed, but the present disclosure not limited thereto.

The pad portion of the external electrodes 400 and 500 is configured to contact connection members such as a solder when the coil component 1000 is mounted on the printed circuit board, and as illustrated in FIG. 3, the pad portion may be formed to protrude beyond the insulating layer 600 on the third surface 103 of the body 100. In a case in which the pad portion of the external electrodes 400 and 500 protrudes as in this example embodiment, when mounting the coil component 1000, a contact area with the connection members such as a solder may be increased to strengthen the adhesion strength, and a gap from the printed circuit board may also increase to reduce the risk of a short circuit.

Referring to FIGS. 1 and 3, the external electrodes 400 and 500 may be formed along internal surfaces of the recesses R1 and R2 and the third surface 103 of the body 100, respectively. For example, the external electrodes 400 and 500 may be formed in the form of a conformal film on the internal surfaces of the recesses R1 and R2 and the third surface 103 of the body 100, and in this case, the external electrodes 400 and 500 may be formed by a thin film process such as a sputtering process or a plating process.

The external electrodes 400 and 500 may be formed of a conductive material such as copper (Cu), aluminum (Al), silver (Ag), tin (Sn), gold (Au), platinum (Pt), palladium (Pd), nickel (Ni), lead (Pb), chromium (Cr), titanium (Ti), or an alloy thereof, but the present disclosure is not limited thereto.

Referring to FIG. 3, the external electrodes 400 and 500 may be formed in a structure of a plurality of layers. For example, first layers 410 and 510 in which the external electrodes 400 and 500 are connected to the coil 300 may be a conductive resin layer including an insulating resin and conductive powder particles including at least one of copper (Cu) and silver (Ag), or a copper (Cu) plating layer. Specifically, second layers 420 and 520 may have a double layer structure of a nickel (Ni) plating layer and a tin (Sn) plating layer.

The first layers 410 and 510 may be formed by electroplating, may be formed by vapor deposition such as sputtering, or may be formed by applying and curing a conductive paste including conductive powder particles such as copper (Cu) and/or silver (Ag), and the second layers 420 and 520 may be formed by the electroplating.

The coil component 1000 according to an example embodiment of the present disclosure may further include an insulating layer covering the body 100 and exposing the first and second external electrodes 400 and 500 on the third surface 103 of the body 100.

Referring to FIGS. 1, 3, and 4, the insulating layer 600 may cover the first surface 102, the second surface 102, the fourth surface 104, the fifth surface 105, and the sixth surface 106 of the body 100, and may be disposed to expose the first and second external electrodes 400 and 500 on the third surface 103 of the body 100.

Furthermore, the insulating layer 600 may be disposed to cover at least partial regions of the external electrodes 400 and 500 disposed in the recesses R1 and R2 or filling portions 610 and 620 to be described below, on the first and second surfaces 101 and 102 of the body 100.

Meanwhile, referring to FIG. 3, the insulating layer 600 may be disposed to be thinner than the external electrodes 400 and 500, and in this case, the external electrodes 400 and 500 may have a shape that partially protrudes from the mounting surface. That is, external surfaces of the second metal layers 420 and 520 may be disposed to protrude beyond an external surface of the insulating layer 600.

In this manner, in a case in which the external electrodes 400 and 500 are disposed to protrude beyond the insulating layer 600, upon mounting the coil component 1000, a contact area with connecting members such as a solder may increase, thereby strengthening the adhesion strength, and the gap from the printed circuit board may increase, thereby reducing the risk of a short circuit.

The insulating layer 600 may be formed by, for example, applying and curing an insulating material including an insulating resin on the surface of the body 100. In this case, the insulating layer 600 may include at least one of a thermoplastic resin such as polystyrene, vinyl acetate, polyester, polyethylene, polypropylene, polyamide, rubber and acrylic, a thermosetting resin such as phenol, epoxy, urethane, melamine, and alkyd, and a photosensitive insulating resin.

Referring to FIG. 3, the coil component 1000 according to an example embodiment may further include filling portions 610 and 620 disposed between the recesses R1 and R2 and the insulating layer 600.

The filling portions 610 and 620 may be configured to improve an appearance of the coil component 1000 by filling corner regions recessed by the formation of the recesses R1 and R2 and to improve the printing quality of the insulating layer 600.

In this example embodiment, each of the first and second filling portions 610 and 620 may be disposed to cover at least a portion of the first external electrode 400 extending to the recess R1 of the first surface 101 and the second external electrode 500 extending to the recess R2 of the second surface 102.

Side surfaces of the filling portions 610 and 620 may be disposed to be substantially coplanar with the first surface 101, the second surface 102, the fifth surface 105, and the sixth surface 106 of the body 100. That is, the side surfaces of the first filling portion 610 may be disposed to be substantially coplanar with the first surface 101, the fifth surface 105, and the sixth surface 106 of the body 100, and the side surfaces of the second filling portion 620 may be disposed to be substantially coplanar with the second surface 102, the fifth surface 105, and the sixth surface 106 of the body 100. Here, substantially forming a coplanar surface denotes that substantially the same plane may be shared, including errors in the process.

The filling portions 610 and 620 may be formed on the external electrodes 400 and 500 disposed in the recesses R1 and R2 by a printing method, a vapor deposition method, a spray coating method, and a film stacking method, but the present disclosure not limited thereto.

The filling portions 610 and 620 may include thermoplastic resins such as polystyrene, vinyl acetate, polyester, polyethylene, polypropylene, polyamide, rubber, and acrylic, a thermosetting resin such as phenol, epoxy, urethane, melamine, and alkyd, a photosensitive resin, parylene, SiOₓ, or SiNₓ.

In this example embodiment, the filling portions 610 and 620 may be omitted, and in this case, the insulating layer 600 may be thickly disposed in a region in which the filling portions 610 and 620 are to be disposed, or may be conformally disposed, but the present disclosure is not limited thereto.

### Second Embodiment

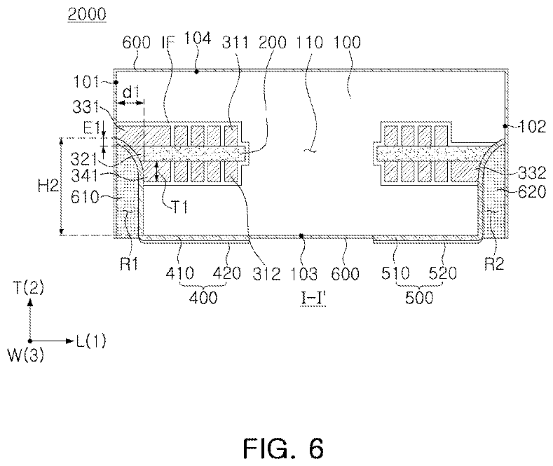

FIG. 6 is a view illustrating a coil component 2000 according to a second embodiment of the present disclosure and is a view corresponding to FIG. 3.

Comparing FIG. 6 with FIG. 3, these drawings are different from each other in that the coil component 2000 according to an example embodiment, since a height H2 of recesses R1 and R2 is formed to be higher than a height H1 of the recesses R1 and R2 of the first embodiment, a partial region of the first lead-out portion 331 disposed on one surface of the support member 200 is also exposed to the recess R1 of the first surface 101.

Accordingly, in describing this example embodiment, only the height H2 of the recesses R1 and R2, and a resultant arrangement relationship between the support member 200, the first lead-out portion 331, the first external via 321, and the first sub lead-out portion 341, which are different from the first embodiment of the present disclosure, will be described, and the description of the first embodiment of the present disclosure may be applied to the remaining components of this example embodiment without any change.

Referring to FIG. 6, at least a portion of the first external electrode 400 disposed in the recess R1 of the first surface 101 may be in contact with the first lead-out portion 331. This may be implemented by removing at least a portion of the first lead-out portion 331 together in the process of forming the recess R1 when the height H2 of the recesses R1 and R2 in the second direction T is formed to be higher than the upper surface of the support member 200.

Accordingly, the coil component 2000 according to an example embodiment may be directly connected to the first external electrode 400 by exposing at least a portion of each of the first lead-out portion 331, the first external via 321, and the first sub lead-out portion 341 through a recess R1 of the first surface 101.

Through the aforementioned structure, the connection reliability between the first coil portion 311 on the upper surface of the support member 200 and the first external electrode may be improved, and a contact area between the coil 300 and the first external electrode 400 may be increased, so that the resistance component Rac of the coil 300 may be further reduced than in the first embodiment.

Meanwhile, FIG. 6 illustrates that the height of the recess R2 of the second surface 102 is also increased in the same manner as that of the recess R1 of the first surface 101, but the scope of this example embodiment is not limited thereto, and the recess R2 of the second surface 102 may have a height lower than that of the upper surface of the support member 200.

However, when the heights of the recess R1 of the first surface 101 and the recess R2 of the second surface 102 are formed to be the same as illustrated in FIG. 6, the process efficiency may be improved because a processing depth of a dicing blade may be kept constant during the pre-dicing process in a coil bar state.

### Third Embodiment and Modified Example Thereof

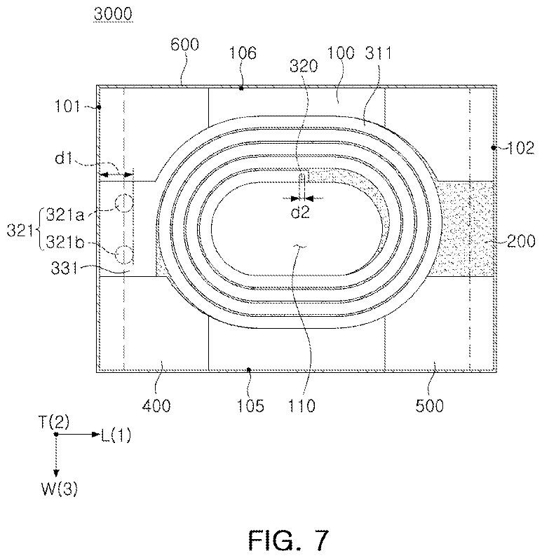

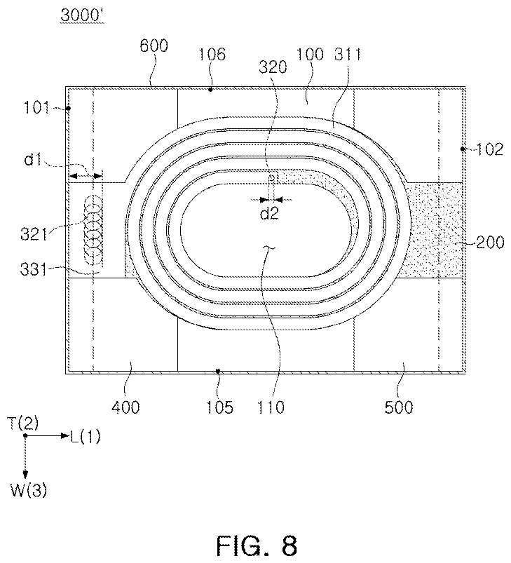

FIG. 7 is a view illustrating a coil component 3000 according to a third embodiment of the present disclosure and is a view corresponding to FIG. 5. FIG. 8 is a view illustrating coil component 3000′ according to a modified example of a third embodiment of the present disclosure, and is a view corresponding to FIG. 7.

Comparing FIG. 7 with FIG. 5, these drawings are different from each other in that in the coil component 3000 according to an example embodiment, a plurality of first external vias 321 are formed.

Accordingly, in describing this example embodiment, only the first external via 321 and a connection relationship with the first external electrode 400, which are different from the first embodiment of the present disclosure, will be described, and the description of the first embodiment of the present disclosure may be applied to the remaining components of this example embodiment without any change.

Referring to FIG. 7, the coil component 3000 according to an example embodiment may include a plurality of first external vias 321a and 321b. Although FIG. 7 illustrates that there are two first external vias 321a and 321b, the scope of this example embodiment is not limited thereto, and the coil component 3000 may include three or more first external vias 321.

Furthermore, in at least one of the plurality of first external vias 321a and 321b, at least a portion thereof may extend to the recess R1 of the first surface 101 and may come into contact with the first external electrode 400.

As the coil component 3000 according to an example embodiment includes a plurality of first external vias 321a and 321b, a connection path between the first lead-out portion 331 and the first sub lead-out portion 341 may be formed in plural form. Accordingly, the connection reliability between the first lead-out portion 331 and the first sub lead-out portion 341 may be improved, and the resistance component R_{dc} may be reduced.

Furthermore, in terms of the possibility of contact between the first external electrode 400 and the first external vias 321a and 321b, even if an arrangement of the first external vias 321a and 321b is slightly misaligned, when at least one of the plurality of first external vias 321a and 321b is in contact with the first external electrode 400, the connection with the coil 300 may be maintained, and the desired effect of the present disclosure, which is strengthening the reliability of the connection between the coil 300 and the external electrodes 400 and 500 and reducing the resistance component Rac of the coil 300, may be stably realized.

Specifically, in the case of a thinned coil component, fine processing is required when forming the recesses R1 and R2, and accordingly, the coil 300 and the external electrodes 400 and 500 may not be in contact or may be in weak contact, resulting in defects in which a connection thereof is cut off even with small external impacts. However, when the plurality of first external vias 321a and 321b are included as in this example embodiment, the defects may be prevented.

Meanwhile, the coil component 3000 according to the third embodiment of the present disclosure includes two first external vias 321a and 321b on one side thereof, but the present disclosure is not limited thereto. As illustrated in FIG. 8, the coil component 3000′ according to a modified example of the third embodiment of the present disclosure includes a plurality of first external vias 321 overlapping each other, and the plurality of first external vias 321 may be formed in a line.

In the case of the coil component 3000′ according to such a modified example, the first external via 321 may be formed to have a larger area, thereby further enhancing a contact probability between the first external electrode 400 and the first external via 321, and further increasing an effect of improving the contact reliability and reducing the coil resistance component R_{dc} accordingly.

### Fourth Embodiment

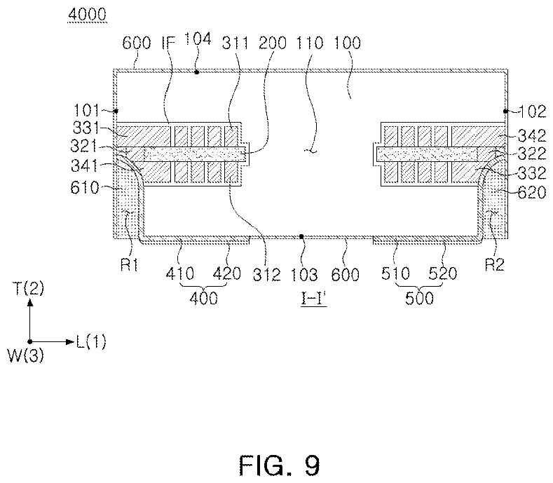

FIG. 9 is a view illustrating a coil component 4000 according to a fourth embodiment of the present disclosure and is a view corresponding to FIG. 3.

Comparing FIG. 9 with FIG. 3, these drawings are different from each other in that the coil component 4000 according to an example embodiment is connected to the second surface 102 of the body 100. Specifically, the coil 300 of the coil component 4000 according to this example embodiment may further include a second sub lead-out portion 342 and/or a second external via 322.

Therefore, in describing this example embodiment, only the second sub lead-out portion 342 and the second external via 322, which are different from the first embodiment of the present disclosure, will be described, and the description of the first embodiment of the present disclosure may be applied to the remaining components of this example embodiment without any change.

Referring to FIG. 9, the coil component 4000 according to an example embodiment may further include a second sub lead-out portion 342 disposed on one surface (upper surface) of the support member 200 and extending to the second surface 102 of the body 100, and further include a second external via 322 for connecting the second lead-out portion 332 and the second sub lead-out portion 342.

The second sub lead-out portion 342 of this example embodiment may be connected to the second lead-out portion 332 through the second external via 322, and may thus be connected to the second coil portion 312 of the other surface (lower surface) of the support member 200.

Accordingly, the second sub lead-out portion 342 is not substantially involved in an electrical connection between the coil 300 and the external electrodes 400 and 500, but has a structure symmetrical to the first lead-out portion 331 at the first surface 101 of the body 100, there improving efficiency between processes.

That is, in the case of a thin-film coil component, the coil 300 may be disposed on the support member 200 and may then be filled with a magnetic material to form the body 100, and a pre-dicing process may be advanced to form recesses R1 and R2 in a coil bar state instead of individual component units. Here, when having a symmetrical structure as in this example embodiment, specification of a surface to perform the pre-dicing process may be unnecessary, thereby improving process efficiency.

Specifically, even if the electrode structure is implemented by performing the pre-dicing process on either of the third surface 3 or the fourth surface 104 of the body 100, the coil 300 and the external electrodes 400 and 500 may be electrically completely connected.

Furthermore, at least a portion of the second external via 322 may be exposed to the recess R2 formed on the second surface 102 of the body 100 and may be in direct contact with the second external electrode 500.

Furthermore, at least a portion of the support member 200 may extend to the recess R2 of the second surface 102 of the body 100 and may come into contact with the second external electrode 500 disposed in the recess R2.

That is, the second external electrode 500 may be in contact with at least a portion of each of the second external via 322, the second lead-out portion 332, and the support member 200.

In the coil component 4000 according to an example embodiment, the second external electrode 500 may be in direct contact with each of the second lead-out portion 332 and the second external via 322, which may improve the connection reliability between the coil 300 and the second external electrode 500 and reduce the resistance component R_{dc} formed between the coil 300 and the second external electrode 500, as compared to a case in which the second external electrode 500 is in contact only with the second lead-out portion 332.

Although not illustrated, a plurality of second external vias 322 of the coil component 4000 according to this example embodiment may also be formed in the same manner as the first external vias 321a and 321b of the third embodiment.

Furthermore, in at least one of the plurality of second external vias 322, at least a portion thereof may extend to the recess R2 of the second surface 102 of the body 100 and may come into contact with the second external electrode 500.

In this case, in the contact between the second external electrode 500 and the second external via 322, even if an arrangement of the plurality of second external vias 322 is slightly misaligned, at least one of the plurality of second external vias 322 may be in contact with the second external electrode 500, thereby stably realizing the desired effect of the present disclosure, which is strengthening the reliability of the connection between the coil 300 and the external electrodes 400 and 500 and reducing the resistance component R_{dc} of the coil 300.

### Fifth Embodiment and Modified Example Thereof

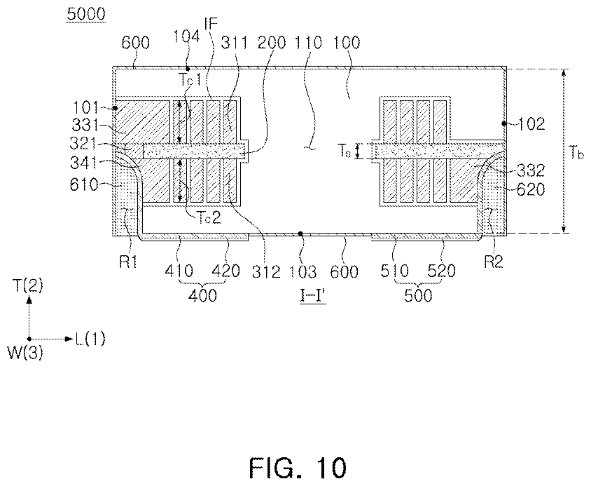

FIG. 10 is a view illustrating a coil component 5000 according to a fifth embodiment of the present disclosure and is a view corresponding to FIG. 3.

Comparing FIG. 10 with FIG. 3, these drawings are different from each other in that a thickness of the coil 300 in the second direction T increases to have a high aspect ratio.

Accordingly, in describing this example embodiment, only the thickness of the coil 300 in the second direction T and a ratio of a thickness T_{b} of the body 100, which are different from the first embodiment of the present invention, will be described, and the description of the first embodiment of the present disclosure may be applied to the remaining components of this example embodiment without any change.

Referring to FIG. 10, a sum of a thickness Tₛ of the support member 200, a thickness T_{c}1 of the first coil portion 311, and a thickness T_{c}2 of the second coil portion 312 may be ⅓ or more of the thickness T_{b} of the body 100. That is, when a region of the body 100 between the coil 300 and the fourth surface 104 is referred to as an upper cover region, and an area of the body 100 between the coil 300 and the third surface 103 is referred to as a lower cover region, a sum of a thickness of the upper cover region and a thickness of the lower cover region may be ⅔ or less of the thickness T_{b} of the body 100.

Meanwhile, the thickness of the upper and lower cover regions may also include a thickness of the insulating layer IF.

Here, the sum of the thickness Tₛ of the support member 200, the thickness T_{c}1 of the first coil portion 311, and the thickness T_{c}2 of the second coil portion 312 may denote a thickness of the body 100, excluding the upper and lower cover regions of the coil 300. When the thickness thereof is greater than or equal to ⅓ of the thickness T_{b} of the body 100, the robustness of the support member 200 and the coil 300 may be improved to obtain an effect of reducing deformation of the coil 300 when the body 100 is formed through thermal compression in the vertical direction of a magnetic sheet.

Furthermore, when the thickness thereof is more than ⅓ of the thickness T_{b} of the body 100, because an aspect ratio of the coil 300 may be made high, a degree of deviation of a winding axis by forming the first and second coil portions 311 and 312 on both surfaces of the support member 200 may be alleviated, thereby improving inductance characteristics.

Here, the thickness T_{c}1 of the first coil portion 311 may denote at least three or more arithmetic average values among dimensions of each of a plurality of line segments spaced apart from each other in the first direction L, where based on an optical microscope image or a scanning electron microscope (SEM) image of an L-T cross-section obtained in the center of the coil portion 5000 in the third direction W, two outermost boundary lines opposing the first coil portion 311 in the second direction T illustrated in the image are connected in parallel with the second direction T. Here, the plurality of line segments in parallel with the second direction T may be spaced apart from each other at equal intervals in the first direction L, but the scope of the present disclosure is not limited thereto.

Meanwhile, the thickness T_{c}2 of the second coil portion 312 and the thickness Tₛ of the support member 200 may also be measured in the same manner as described above.

In the coil component 5000 according to an example embodiment, since the coil 300 has a high aspect ratio, the inductance capacitance may be increased even with the same number of turns, and the resistance component R_{dc} of the coil 300 may be reduced.

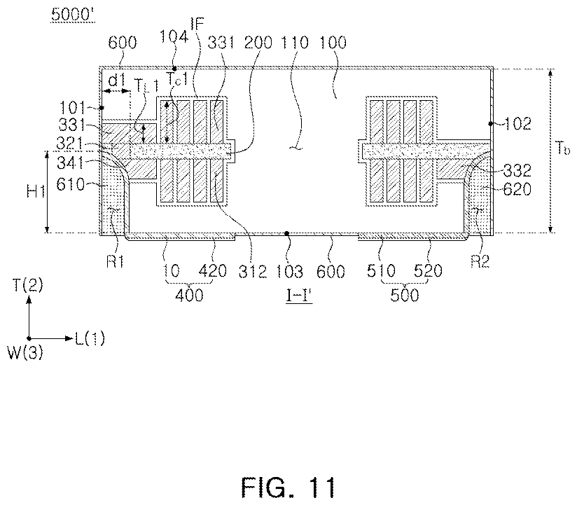

FIG. 11 is a view illustrating a coil component 5000′ according to a modified example of the fifth embodiment of the present disclosure, and is a view corresponding to FIG. 10.

Comparing FIG. 11 with FIG. 10, these drawings are different from each other in that the thicknesses of the first lead-out portion 331, the second lead-out portion 332, and the first sub lead-out portion 341 of the coil 300 in the second direction T are different from each other.

Accordingly, in describing the modified example, only the thicknesses of the first lead-out portion 331, the second lead-out portion 332, and the first sub lead-out portion 341, and a resultant magnitude relationship between a distance d1 from an innermost boundary line between the first external via 321 and the support member 200 to an extension line of an outermost boundary line of the first lead-out portion 331 and a thickness T_{L}1 of the first lead-out portion 331, which are different from the fifth embodiment of the present disclosure, will be described, and the description of the fifth embodiment of the present disclosure may be applied to the remaining components of this example embodiment without any change.

Referring to FIG. 11, in an L-T cross-section of a coil component 5000′ according to a modified example, a distance d1 in the first direction from an innermost boundary line between the first external via 321 and the support member 200 to an extension line of an outermost boundary line of the first lead-out portion 331 may be greater than or equal to the thickness T_{L}1 of the first lead-out portion 331 in the second direction T.

Furthermore, the thickness T_{c}1 of the first coil portion 311 in the second direction T may be greater than or equal to the thickness T_{L}1 of the first lead-out portion 331 in the second direction T.

Meanwhile, in FIG. 11, for example, only the thickness T_{L}1 of the first lead-out portion 331 is used as a reference, but the scope of the modified example is not limited thereto, and the thicknesses of the second lead-out portion 332 and/or the first sub lead-out portion 341 may be formed thin to have a low aspect ratio.

In the coil component 5000′ according to the modified example, an aspect ratio of the first and second coil portions 311 and 312 may be made high to increase inductance capacitance, and at the same time, the thickness of the first lead-out portion 331, the second lead-out portion 332, and the first sub lead-out portion 341 that does not form a turn may be formed thin to have a low aspect ratio, so that a space to be filled with the magnetic material may be further secured in the body 100 of the same size, thereby improving inductance characteristics.

That is, a space to be filled with the magnetic material may be additionally secured in a region of the body 100 between the first lead-out portion 331 and the fourth surface 104, in a region of the body 100 between the second lead-out portion 332 and the third surface 103, and in a region of the body 100 between the first sub lead-out portion 341 and the third surface 103.

### Sixth Example and Modified Example Thereof

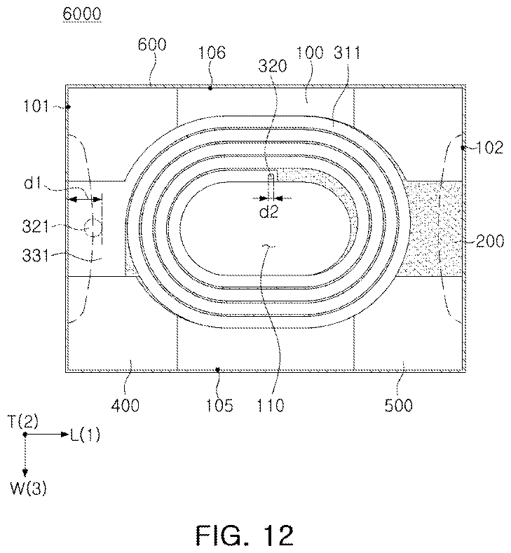

FIG. 12 is a view illustrating a coil component 6000 according to a sixth embodiment of the present disclosure and is a view corresponding to FIG. 5.

Comparing FIG. 12 with FIG. 5, these drawings are different in the shapes of the recesses R1 and R2 formed in the first surface 101 and the second surface 102 of the body 100, and the shapes of the external electrodes 400 and 500 disposed on the recesses R1 and R2 accordingly.

Accordingly, in describing this example embodiment, only the shapes of the recesses R1 and R2 respectively formed in the first surface 101 and the second surface 102 of the body 100, and the shapes of the external electrodes 400 and 500 disposed in the recesses R1 and R2, which are different from the first embodiment of the present disclosure, will be described, and the description of the first embodiment of the present disclosure may be applied to the remaining components of this example embodiment without any change.

Referring to FIG. 12, the recesses R1 and R2 of this example embodiment may be spaced apart from at least one of the fifth surface 105 and the sixth surface 106 of the body 100.

In the case of the first embodiment, when the recesses R1 and R2 are formed, the pre-dicing process may be performed in the form of a line through a dicing blade in the coil bar state, but in this example embodiment, using a laser or the like, the recesses R1 and R2 may be formed only in a partial region of the body 100 that is not in a line shape.

Furthermore, the recesses R1 and R2 of this example embodiment may include curved surfaces. Specifically, at least one of the recess R1 of the first surface 101 and the recess R2 of the second surface 102 of the body 100 may include a curved surface that is concave toward an interior of the body 100, and a region including a curve may be formed on an L-W cross section, perpendicular to the second direction T, which is cut to generate the recesses R1 and R2, and may have a circular segment shape.

The recesses R1 and R2 of the coil component 6000 according to this example embodiment are also in contact with the first external via 321 as in the first embodiment, and accordingly, while improving the reliability of the connection between the coil 300 and the external electrodes 400 and 500 and reducing the resistance component R_{dc} of the coil 300, the volume occupied by the recesses R1 and R2 in the coil component 6000 may be reduced, thereby securing a space to be filled with a magnetic material and improving inductance characteristics.

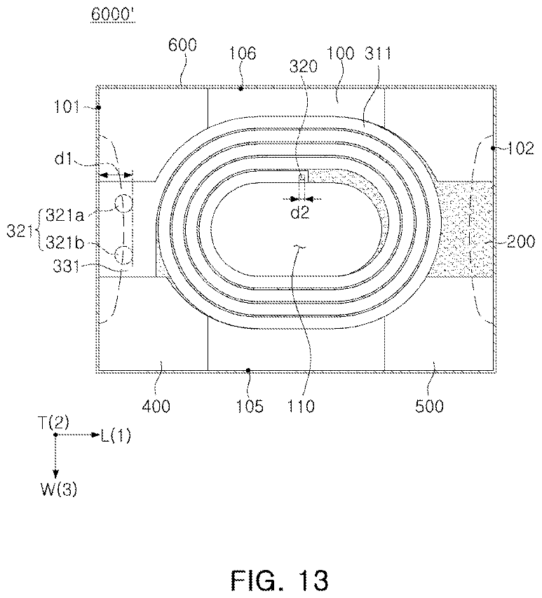

FIG. 13 is a view illustrating a coil component 6000′ according to a modified example of the sixth embodiment of the present disclosure and is a view corresponding to FIG. 12.

Comparing FIG. 13 with FIG. 12, there is a difference in that a plurality of first external vias 321 are formed.

Accordingly, in describing this modified example, only the first external via 321 and a connection relationship with the first external electrode 400, which are different from the sixth embodiment of the present disclosure, will be described, and the description in the sixth embodiment of the present disclosure may be applied to the remaining components of this modified example without any change.

Referring to FIG. 13, the coil component 6000′ according to a modified example may include a plurality of first external vias 321a and 321b. In FIG. 13, two first external vias 321a and 321b are illustrated, but the scope of this example embodiment is not limited thereto, and the coil component 6000′ may include three or more first external vias 321.

Furthermore, in at least one of the plurality of first external vias 321a and 321b, at least a portion thereof may extend to the recess R1 of the first surface 101 and may come into contact with the first external electrode 400.

As the coil component 6000′ according to this modified example may include the plurality of first external vias 321a and 321b, a connection path between the first lead-out portion 331 and the first sub lead-out portion 341 may be formed in plural form, thereby improving the reliability of a connection between the first lead-out portion 331 and the first sub lead-out portion 341, and reducing the resistance component R_{dc}.

Furthermore, in terms of the possibility of contact between the first external electrode 400 and the first external vias 321a and 321b, even if an arrangement of the first external vias 321a and 321b is slightly misaligned, when at least one of the plurality of first external vias 321a and 321b is in contact with the first external electrode 400, the connection with the coil 300 may be maintained, and the desired effect of the present disclosure, which is strengthening the reliability of the connection between the coil 300 and the external electrodes 400 and 500 and reducing the resistance component Rac of the coil 300, may be stably realized.

Specifically, in the case of a thinned coil component, fine processing is required when forming the recesses R1 and R2, and accordingly, the coil 300 and the external electrodes 400 and 500 may not be in contact or may be in weak contact, resulting in defects in which the connection is cut off even with small external impacts. However, when a plurality of first external vias 321a and 321b are included as in this example embodiment, the defects may be prevented.

The above-described effect is a more required effect in the case of the sixth embodiment in which the size of the recesses R1 and R2 becomes smaller.

### Seventh Embodiment

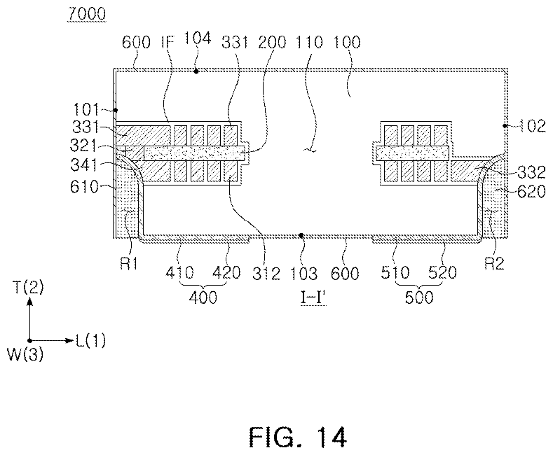

FIG. 14 is a view illustrating a coil component 7000 according to a seventh embodiment of the present disclosure and is a view corresponding to FIG. 3.

Comparing FIG. 14 with FIG. 3, these drawings are different from each other in that a portion of the support member 200 at the second surface 102 of the body 100 is removed.

Accordingly, in describing this example embodiment, only the support member 200 and a resultant arrangement relationship between the second lead-out portion 332 and the insulating film IF, which are different from the first embodiment of the present disclosure, will be described, and the description of the first embodiment of the present disclosure may be applied to the remaining components of this example embodiment without any change.

Referring to FIG. 14, the coil component 7000 according to this example embodiment may be disposed such that the support member 200 is spaced apart from the second surface 102 of the body 100.

A region of the support member 200 adjacent to the second surface 102 of the body 100 does not require a formation of an external via, unlike a region adjacent to the first surface 101 of the body 100, and thus, after the second lead-out portion 332 is disposed on the support member 200, a partial region of the support member 200 may be removed by a laser or the like. In this case, an upper surface of the second lead-out portion 332 may be covered by the insulating film IF for insulation from the body 100.

When a portion of the support member 200 is removed as in this example embodiment, a space to be filled with a magnetic material may be further secured by the volume of the support member 200 removed in the coil component of the same size, thereby increasing an effective volume and further improving inductance characteristics.

### Eighth Embodiment

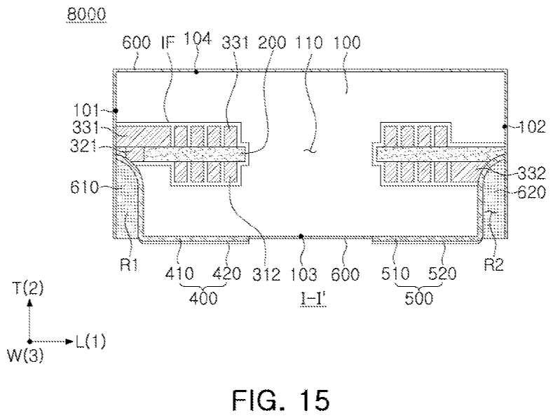

FIG. 15 is a view illustrating a coil component 8000 according to an eighth embodiment of the present disclosure and is a view corresponding to FIG. 3.

Comparing FIG. 15 with FIG. 3, these drawings are different from each other in that the first sub lead-out portion 341 extending to the recess R1 of the first surface 101 of the body 100 is omitted.

Accordingly, in describing this example embodiment, only a connection relationship between the first external electrode 400 and the coil 300 in the recess R1 of the first surface 101, which is different from the first embodiment of the present disclosure will be described, and the description of the first embodiment of the present disclosure may be applied to the remaining components of this example embodiment without any change.

Referring to FIG. 15, in the coil component 8000 according to this example embodiment, a first lead-out portion 331 and a first external electrode 400 may be directly connected to each other through a first external via 321.

Furthermore, at least a portion of the first external electrode 400 may be in contact with the first external via 321 and the support member 200.

In the coil component 8000 according to the present embodiment, the first external via 321 may be in charge of an electrical connection function between the first coil unit 311 and the first external electrode 400, and a region in which a first sub lead-out portion is omitted may be filled with a magnetic material forming the body 100. Accordingly, an effective volume may increase simultaneously with maintaining the electrical connection between the coil 300 and the external electrodes 400 and 500, thereby improving inductance characteristics.

On the other hand, in the case of this example embodiment, a plurality of first external vias 321 may also be formed, and in at least one of the plurality of first external vias 321, at least a portion thereof may extend to the recess R1 of the first surface 101 and may come into contact with the first external electrode 400.

In the case of this example embodiment in which the first lead-out portion 331 and the first external electrode 400 are connected only through the first external via 321, the plurality of first external vias 321 may be formed, thereby increasing the effect of improving connection reliability and reducing the resistance component R_{dc} of the coil 300.

### <Manufacturing Method of Coil Component>

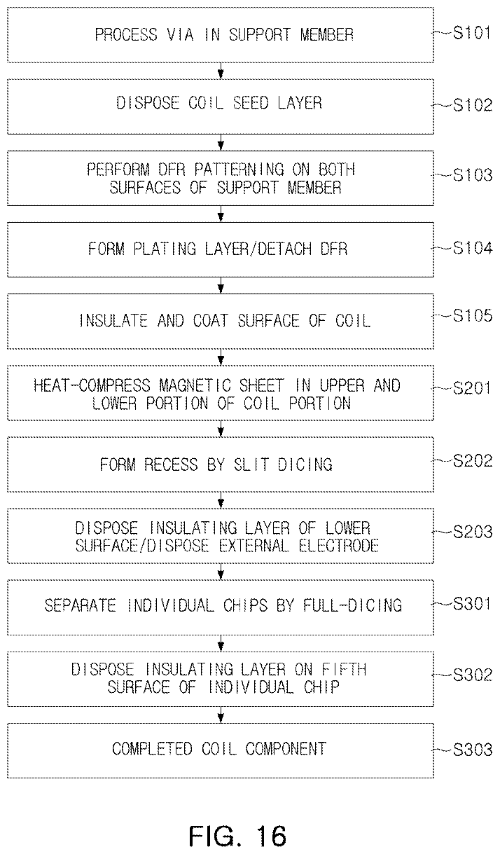

FIG. 16 is a flowchart illustrating a method of manufacturing a coil component according to an embodiment of the present disclosure.

Referring to FIG. 16, a manufacturing method of a coil component according to an example embodiment of the present disclosure may include an operation of forming a plurality of via holes in a support member 200 (S101), an operation of disposing a seed layer on an internal surface of the via hole and the support member 200 (S102), an operation of disposing and patterning a plating resist on the support member 200 (S103), an operation of forming the coil 300 through plating on the support member 200 (S104), an operation of forming an insulating film IF on a surface of the coil (S105), an operation of forming the body 100 by compressing and curing a plurality of magnetic sheets in a vertical direction of the support member 200 in which the coil 300 is disposed (S201), an operation of forming a slit by cutting a portion of the body 100 on one surface of the body 100 (S202), an operation of disposing an insulating layer 600 in a partial region of one surface 103 of the body 100 and disposing external electrodes 400 and 500 in a remaining region and the slit (S203), and an operation of separating a central region of the slit into the individual coil component 1000 by dicing (S301).

Furthermore, the method thereof may further include an operation of disposing the insulating layer 600 in a region in which the body 100 is exposed, among the separated coil components 1000.

On the other hand, the slit may be formed through pre-dicing by a dicing blade in a state in which a magnetic sheet is stacked on a coil bar, and then, when the coil bar is separated into individual coil components 1000 through full-dicing, the slit denotes a part corresponding to the recesses R1 and R2.

In the operations of FIG. 16, operations S101 to S105 correspond to a coil bar state in which a plurality of coils 300 are connected in a grid, operation S201 to S203 correspond to a state in which a magnetic body is formed on the coil bar, and operation S301 to S303 correspond to a state of individual coil components 1000.

Referring to FIG. 16, first, a plurality of via holes may be formed in the support member 200 (S101). Here, the plurality of via holes correspond to a region in which an internal via 320 or an external via 321 is to be disposed through a plating process, and may be formed through mechanical drilling or CO₂ laser irradiation.

Next, a seed layer may be disposed on the support member 200 to form the coil 300 by plating (S102). The seed layer may also extend to an internal surface of the via hole. Seed layers disposed on one surface and the other surface of the support member 200 may be included in first and second coil portions 311 and 312, respectively, and the seed layer disposed on the internal surface of the via hole may be included in the internal via 320 or the external via 321.

Next, a plating resist may be disposed on the support member 200 and patterned according to a shape of a desired coil 300 (S103). A dry film photoresist (DFR) may be used as the plating resist, but the present disclosure is not limited thereto.

Next, the coil 300 may be formed on the support member 200 by plating (S104). During electroplating, a plating growth may occur in the seed layer in a patterned form on the plating resist, so that the coil 300, i.e., a first coil portion 311, a second coil portion 312, an internal via 320, a first external via 321, a first lead-out portion 331, the second lead-out portion 332, and a first sub lead-out portion 341 may be disposed. After the coil 300 is formed, the used plating resist may be removed (detached).

Next, an insulating film IF may be formed on the surface of the coil 300 (S105). The insulating film IF may insulate the coil 300 from the body 100, and may include parylene.

Next, a plurality of magnetic sheets may be stacked in the vertical direction on the support member 200 in which the coil 300 is disposed, heated, pressed, and cured to form the body 100 (S201). The body 100 here refers to a constituent in which a plurality of support members 200 and a plurality of coil components 300 connected to each other are embedded, in a the coil bar state.

Next, a portion of the body 100 may be cut on one surface 103 of the body 100 to form the recesses R1 and R2 (S202). The recesses R1 and R2 may be formed by removing a portion of the body 100 using a dicing blade, and depths of the recesses R1 and R2 may be adjusted to cut at least a portion of the external via 321.

Next, the insulating layer 600 may be disposed on a partial region of one surface 103 of the body 100, and external electrodes may be disposed in the remaining regions and the recesses R1 and R2 (S203). Specifically, insulation printing of a lower surface may be performed on a region between regions in which the external electrodes 400 and 500 are to be disposed on one surface 103 of the body 100, and insulation of the upper surface may be collectively performed before performing the dicing on the individual coil components 1000, thereby increasing process efficiency. The external electrodes 400 and 500 may be disposed by a plating process or a sputtering process.

Next, a full-dicing process may be performed to separate the coil bar state into individual coil components 1000 (S301). The dicing process may be performed using the dicing blade along a set line, and uniform recesses R1 and R2 may be formed by performing the dicing process so as to pass through a central portion of the slit.

Next, an insulating layer 600 may be disposed in a region in which the body 100 is externally exposed in each of the separated coil components 1000 (S302). The insulating layer 600 may include at least one of a thermoplastic resin such as polystyrene, vinyl acetate, polyester, polyethylene, polypropylene, polyamide, rubber and acrylic, a thermosetting resin such as phenol, epoxy, urethane, melamine and alkyd, and a photosensitive insulating resin.

The coil component 1000 according to an example embodiment of the present disclosure may be manufactured through the above-described process (S303).

As described above, an example embodiment of the present disclosure has been described, but those of ordinary skill in the art may make various modifications or changes by adding, changing, or deleting components without departing from the scope of the present disclosure defined by the appended claims, and these modifications or changes should be construed as being included in the scope of the present disclosure.

What is claimed is:

1. A coil component comprising:
a body having a first surface and a second surface opposing each other in a first direction and each having a recess formed therein, and a third surface and a fourth surface connecting the first surface and the second surface and opposing each other in a second direction;
a support member disposed in the body and having one surface and another surface opposing each other;
a coil including first and second coil portions disposed on the support member and having at least one turn, an internal via for connecting the first coil portion and the second coil portion, a first lead-out portion extending from an outermost turn of the first coil portion to the first surface, a first sub lead-out portion disposed on the other surface of the support member, a first external via for connecting the first lead-out portion and the first sub lead-out portion, and a second lead-out portion extending from an outermost turn of the second coil portion to the second surface;
a first external electrode disposed on the third surface and extending onto the recess of the first surface to be connected to the first lead-out portion; and
a second external electrode disposed on the third surface and extended onto the recess of the second surface to be connected to the second lead-out portion,
wherein at least a portion of the first external via is in contact with the first external electrode.

2. The coil component according to claim 1, wherein at least a portion of the first external via is coplanar with the recess of the first surface.

3. The coil component according to claim 1, wherein a surface of the recess on which the first external via is in contact with the first external electrode is an inclined surface.

4. The coil component according to claim 1, wherein the first external via has an upper surface and a lower surface opposing each other in the second direction, and
a cross-sectional area of the lower surface of the first external via is smaller than a cross-sectional area of the upper surface thereof.

5. The coil component according to claim 1, wherein at least a portion of the support member extends to the recess of the first surface and comes into contact with the first external electrode.

6. The coil component according to claim 1, wherein in a cross-section in parallel with the first direction and the second direction, a distance in the first direction from an innermost boundary line between the first external via and the support member to an extension line of an outermost boundary line of the first lead-out portion is greater than or equal to a diameter of the internal via.

7. The coil component according to claim 1, wherein the number of turns of at least one of the first and second coil portions is 3.5 turns or more.

8. The coil component according to claim 1, wherein at least a portion of the first external electrode disposed in the recess of the first surface is in contact with the first lead-out portion.

9. The coil component according to claim 1, wherein the coil further includes a second sub lead-out portion disposed on one surface of the support member and extending to the second surface.

10. The coil component according to claim 9, wherein the coil further includes a second external via for connecting the second lead-out portion and the second sub lead-out portion.

11. The coil component according to claim 10, wherein at least a portion of the second external via is in contact with the second external electrode.

12. The coil component according to claim 9, wherein at least a portion of the support member extends to the recess of the second surface and is in contact with the second external electrode.

13. The coil component according to claim 10, wherein the second external via is provided as a plurality of second external vias, and
in at least one of the plurality of second external vias, at least a portion thereof extends to the recess of the second surface and comes into contact with the second external electrode.

14. The coil component according to claim 1, wherein a sum of thicknesses of the support member and the first and second coil portions in the second direction is ⅓ or more of a thickness of the body in the second direction.

15. The coil component according to claim 1, wherein in a cross-section in parallel with the first direction and the second direction, a distance in the first direction from an innermost boundary line between the first external via and the support member to an extension line of an outermost boundary line of the first lead-out portion is greater than or equal to a thickness of the first lead-out portion in the second direction.

16. The coil component according to claim 15, wherein a thickness of the first coil portion in the second direction is greater than or equal to a thickness of the first lead-out portion in the second direction.

17. The coil component according to claim 1, wherein the body further includes a fifth surface and a sixth surface opposing each other in a third direction, perpendicular to the first direction and the second direction, respectively, and
each of the recesses is disposed in a region between the first surface and the third surface and between the second surface and the third surface.

18. The coil component according to claim 17, wherein the recess extends to the fifth surface and the sixth surface in the third direction.

19. The coil component according to claim 17, wherein the recess is spaced apart from at least one of the fifth surface and the sixth surface.

20. The coil component according to claim 19, wherein the recess includes a curved surface.

21. The coil component according to claim 1, wherein the first external via is provided as a plurality of first external vias, and
in at least one of the plurality of first external vias, at least a portion thereof extends to the recess of the first surface and comes into contact with the first external electrode.

22. The coil component according to claim 21, wherein the plurality of first external vias overlap each other and are disposed in a line.

23. The coil component according to claim 1, wherein a ratio (H1/T1) of a height H1 of the recess of the first surface in the second direction to a thickness T1 of the first sub lead-out portion in the second direction is 4.4 or more and 6.4 or less.

24. The coil component according to claim 1, wherein a height of the recess of the first surface in the second direction is 0.22 mm or more and 0.32 mm or less.

25. The coil component according to claim 1, wherein the support member is spaced apart from the second surface.

26. The coil component according to claim 25, wherein at least a portion of the second lead-out portion is spaced apart from the support member.

27. A coil component comprising:
a body having a first surface and a second surface each having a recess formed therein and opposing each other, and having a third surface and a fourth surface connecting the first surface and the second surface and opposing each other;
a support member disposed in the body;
a coil portion disposed on at least one surface of the support member;
a lead-out portion extending from an outermost turn of the coil portion to the first surface;
an external electrode disposed on the third surface and extending onto the recess of the first surface; and
an external via for connecting the lead-out portion and the external electrode,
wherein at least a portion of the external electrode is in contact with the external via and the support member.

28. The coil component according to claim 27, wherein the external via is provided as a plurality of external vias, and
in at least one of the plurality of external vias, at least a portion thereof extends into the recess and comes into contact with the external electrode.

29. A manufacturing method of a coil component, the method comprising:
forming a plurality of via holes in a support member;
disposing a seed layer on an internal surface of the via hole and the support member;
disposing and patterning a plating resist in the support member;
forming a coil through plating in the support member;
forming an insulating film on a surface of the coil;
forming a body by compressing and curing a plurality of magnetic sheets in a vertical direction of the support member in which the coil is disposed;
forming a recess by cutting a portion of the body from one surface of the body;
disposing an insulating layer on a partial region of one surface of the body and disposing an external electrode on a remaining region and the recess; and
separating a central region of the recess into individual coil components by dicing,
wherein the coil includes an external via disposed in at least one of the plurality of via holes, and at least a portion of the external electrode is in contact with the external via.

30. The manufacturing method of a coil component according to claim 29, further comprising:
disposing the insulating layer in a region in which the body is exposed, among the separated coil components.

31. The manufacturing method of a coil component according to claim 29, wherein the recess is formed to expose at least a portion of the external via.

32. The manufacturing method of a coil component according to claim 29, wherein a surface on which the external via is in contact with the external electrode is formed as an inclined surface.

33. The manufacturing method of a coil component according to claim 29, wherein the external via is formed in plural form.

34. A coil component comprising:
a body having a first surface and a second surface each having a recess formed therein and opposing each other in a first direction, and having a third surface and a fourth surface connecting the first surface and the second surface and opposing each other in a second direction;
a support member disposed in the body;
a coil portion disposed on at least one surface of the support member;
a lead-out portion extending from an outermost turn of the coil portion to the first surface;
an external electrode disposed on the third surface and extending onto the recess of the first surface; and
an external via penetrating through the support member to connect the lead-out portion and at least a portion of the external electrode,
wherein the external via overlaps the recess of the first surface in the second direction.

35. The coil component according to claim 34, wherein at least a portion of the external electrode is in contact with the external via and the support member.

36. The coil component according to claim 34, wherein the support member has one surface and another surface opposing each other, and
an end of the external electrode at the first surface of the body is disposed between the one surface and the other surface of the support member.

37. The coil component according to claim 34, wherein the support member has one surface and another surface opposing each other, the one surface facing the fourth surface of the body and the other surface facing the third surface of the body, and
an end of the external electrode at the first surface of the body is disposed between the one surface of the support member and the fourth surface of the body.

38. The coil component according to claim 34, wherein in a cross-section in parallel with the first direction and the second direction, a distance in the first direction from an innermost boundary line between the external via and the support member to an extension line of an outermost boundary line of the first lead-out portion is greater than or equal to a thickness of the lead-out portion in the second direction.

39. The coil component according to claim 34, wherein the external via is provided as a plurality of external vias, and the plurality of external vias are in contact with at least a portion of the external electrode.
